(19) United States
(12) Patent Application Publication
(10) Pub. No.: US 2011/0244095 A1
(43) Pub. Date: Oct. 6, 2011

(54) Method for Coating Food Products

(75) Inventor: Alberto Sardo, Chateaurenard (FR)

(73) Assignee: Xeda International, Saint Andiol (FR)

(21) Appl. No.: 13/120,400

(22) PCT Filed: Feb. 2, 2009
(86) PCT No.: PCT/FR2009/050153

§ 371 Date: Apr. 22, 2011

(30) Foreign Application Priority Data
Sep. 22, 2008 (FR) 08566351

(51) Int. Cl. A23B 7/16; A23P 1/08

(52) U.S. Cl. 426/302; 523/100

(57) ABSTRACT

A method for coating food products includes applying, on food products, a composition containing one or more film-forming agents in a solvent, wherein application is carried out by atmospheric pressure showering of the composition or by immersion into the composition.

### FIELD OF THE INVENTION

The present invention relates to a method for coating food products.

### BACKGROUND INFORMATION

Fresh foods, such as fruits and vegetables, in particular citrus fruits, are generally coated before marketing to improve their shelf life and appearance for the consumer.

Resins used for food purposes are used, in particular, to coat citrus fruits. However, their use is limited due to their poor solubility in ethanol, a solvent approved for use with food products.

The current practice is to apply these resins or waxes for use in food products by spraying or misting with spray guns. Thus, FR 0753308 discloses the application of resin and terpene compounds on fruits or vegetables by spraying the fruits or vegetables, which are placed on conveyor belts, with pressurized jets. This manner of application, like misting or atomization, entails the formation of a substantial fog, which spreads over a wide area of the conveyor belt and mechanical parts, and also pollutes the atmosphere. After the evaporation of the solvents, the fine droplets then leave a dry resin residue that clogs the mechanical device.

Application by spraying, misting, or spraying necessitates very good dissolution of the resins in the application compound, such that additives are always necessary.

Furthermore, it has been observed that application by spraying, misting, or atomization does not allow for satisfactory coverage: in fact, pressurized application results in partial evaporation of the solvent, such that solid particles are applied to the fruits or vegetables, causing localized accumulation of solid residues.

Non-homogeneous coverage does not allow for proper inspection for loss of weight and/or the breathing of fruits or vegetables.

Lastly, these pressurized systems are complex and costly.

Thus, it is desirable to make available a new, improved method for coating food products by means of resins or waxes.

### SUMMARY

A new method of coating food products, which allows said problems to be avoided, is described below.

Thus, with regard to its primary purpose, example embodiments of the present invention provide a method for the coating of food products, including the application on those food products of a compound consisting of one or more filmogenic agents in a solvent, characterized in that the application is carried out by showering the food products with said compound at atmospheric pressure or by immersion in said compound.

In an example embodiment, said solvent is selected from amongst water and a light alcohol or alkane, in particular a C2-C3 alcohol or a C6-C10 alkane. Suitable alcohols and alkanes include without limitation ethanol and hexane.

The use of alcohol as a solvent is particularly advantageous in that it acts to disinfect or sterilize the food product of any contamination on its surface.

Preferably, if a water-soluble solvent, such as an alcohol, is used, the composition of the coating should additionally include a base. In fact, a substantial loss of resin solubility in said water-soluble solvent may result in the presence of residual humidity (e.g., water condensation on the food products to be treated, ambient humidity). This loss of solubility also causes a low-quality coating, such that the food products so treated will not have the desired shiny appearance. The addition of a base into the water-soluble-solvent-based coating composition allows for improved solubility of the resin in the solvent in the presence of water, such that the coating is of satisfactory quality even in the presence of water.

Acceptable bases include, without limitation, any organic or mineral base, such as ammonia, soda, potash, and amines, such as diethylamine and morpholine.

Generally, the base ranges from 0 to 10% by weight of the coating composition, preferably between 0.1 and 5%, more preferably between 1 and 5%.

“Filmogenic agent” refers to any agent capable of forming an edible, permeable or semipermeable film capable of reducing and/or preventing gas exchange by said food product with the surrounding air. Thus, said filmogenic agent(s) is/are selected, in particular, from amongst the lecithin resins and derivatives, carboxymethylcellulose, polymerized sugar derivatives (sucroesters and sucroglycerides), and waxes such as oxidized polyethylene wax, microcrystalline wax, carnauba wax, candelilla wax, beeswax, and mixtures thereof.

The resin may be chosen from amongst coumarone-indene resin, shellac, or resins including abietic acid, and/or one or more abietic acid ester(s), or mixtures thereof, such abietic acid ester(s) being chosen from amongst abietic acid ester with glycerol or pentaerythritol. Said resins that include abietic acid, one or more abietic acid ester(s), or mixtures thereof are preferably chosen from amongst the resins ester gum, Pexalyn®, Pentalyn®, and Permalyn®.

The coating compound may also include one or more terpenes, in particular chosen from amongst non-oxygenated terpenes, such as the pinenes and limonene.

“Food product” refers to any food, such as fruits, vegetables, cheeses, or eggs, in particular those normally coated for preservation, especially fruits or vegetables.

In the first respect, said filmogenic agent is in solution in a solvent.

More preferably, the compound is chosen from amongst:
solutions of shellac in an alcohol and/or water;
solutions of abietic acid, abietic acid esters, and/or mixtures thereof in an alcohol and/or water, with or without a terpene,
solutions of coumarone-indene resins in an alkane and/or water or mixtures thereof;
solutions of lecithin(s) and/or derivatives in water,
solutions of carboxymethylcellulose in water,
solutions of polymerized sugar derivatives in water.

In another respect, said filmogenic agent is in aqueous emulsion.

Generally, the coating compound is chosen from amongst aqueous emulsions of oxidized polyethylene wax, microcrystalline wax, carnauba wax, candelilla wax, beeswax, and mixtures thereof.

In example embodiments, said coating composition may be chosen from amongst:

i) compounds of resin(s) and/or sucroester(s) used for food purposes, a solvent with or without an alkaline medium and/or in the presence of terpenes;

ii) compounds of resin(s) used for food purposes in an alkaline medium in water;

iii) compounds of wax(es) used for food purposes in anionic aqueous emulsion;

iv) mixtures of ii) and iii).

Generally, the wax-based coating compounds contain 5-30% wax in a solvent, preferably 10%-20%, by weight.

Preferably, said compound is applied by showering the food products to be coated, placed on a conveyor belt, with said compound at atmospheric pressure.

As noted above, this atmospheric-pressure shower is carried out without the use of jets, sprinklers, or misters.

According to example embodiments of the present invention, the showering may be carried out by the overflow of the feed reservoir of said compound, by spilling the compound that falls through gravity onto the food products located on a first section of the conveyor, under the spill zone, or by dripping through perforations in the feed reservoir.

Advantageously, the shower may be improved by the placement of reeds to homogenize the shower on the food products.

After passing through this first area, the showered food products are then transported via the conveyor to a second area on top of a discharge device, such as buckets.

The compounds generally include:
between 1% and 35% by weight in resin(s);
between 0% and 50% by weight in terpene(s);
between 15% and 99% by weight in solvent; and
between 0 and 10% by weight of base.

The composition may be, in particular, one of the following:
coumarone-indene in hexane;
glyceryl abietate in ethyl alcohol;
shellac in ethyl alcohol; with or without limonene and/or a base.

More precisely, the following compounds are preferred:
coumarone-indene resin: 7%
hexane: 93%;

or
glyceryl abietate: 11%,
ethyl alcohol: 67%,
morpholine: 2%,
limonene: 20%;

or
shellac: 9%,
ethyl alcohol: 89%,
ammonia: 2%.

The above compounds may also include other solvents, vegetable oils, or emulsifiers.

Example embodiments of the present invention provide coating compounds for food products including:
between 1% and 35% by weight in resin(s);
between 0% and 50% by weight in terpene(s);
between 15% and 99% by weight in solvent; and
between 0.1 and 10% by weight of base.

Preferably, the compound is applied after harvesting and before marketing of food products, at room temperature. The compounds may be applied one or more times.

Preferably, the compounds are applied to food products that have been previously dried.

The percentages indicated here are by weight.

The coating compounds are preferably applied in their pure state, without prior dilution.

The amount of compound to be applied depends on the nature of the food products in question and the method of application selected. Generally, between 1000 and 5000 cm³ of the composition is applied per ton of food product, preferably between 2 and 10 liters/t.

The solvent of the compounds in solution is generally evaporated in air by aspiration followed by extraction or absorption.

Resins may include, in particular, coumarone-indene resins, shellac resins (E904), pine resins, abietic acid, or abietic acid esters such as esters with glyceryl or pentaerythritol (E445), and resins chemically ester-modified by creating the maleic or fumaric adduct, or mixtures thereof.

The expression “abietic acid ester(s)” refers to one or more esters of abietic acid with an alcohol, mixtures thereof, as well as any resin including one or more abietic acid esters or mixtures thereof. In particular, the ester of abietic acid with glyceryl or pentaerythritol is preferred, or, more preferably, glyceryl abietate. These include, in particular, the commercial resins Ester Gum, Pexalyn®, or Pentalyn®, marketed by Hercules Inc., or Permalyn®, marketed by Eastman.

Non-oxygenated terpenes may include pinenes and limonene, especially limonene.

The expression fruits or vegetables refers preferably to the treatment of citrus fruits such as oranges, limes, clementines, pineapples, mandarin oranges, or apples, or any fruit or vegetable that is normally resin coated.

The various surfactants or emulsifiers are known to persons skilled in the art. According to this invention, “emulsifier” refers to any agent normally used for this purpose, such as ethoxylated fatty alcohols, ethoxylated fatty acids, ethoxylated alkylphenols, or any other nonionic product.

The surfactants preferably used are anionic or nonionic surfactants.

Examples of nonionic surfactants that can be used include without limitation the product of condensation of an aliphatic fatty acid, preferably C₈-C₂₂, with a C₂-C₃ alkylene oxide. The C₂-C₃ alkylene oxide may be ethylene oxide, propylene oxide, or a mixture of ethylene oxide and propylene oxide in any proportions. An example of such surfactants is the condensation product of lauryl alcohol (or n-dodecyclic alcohol) with 30 moles of ethylene oxide.

The emulsifiers may also contain other agents customarily used in coating waxes.

The nonionic emulsifiers include, in particular, sucroesters, ethoxylated moneolate sorbitans, ethoxylated fatty acids, lecithin, and ester-modified fatty acids such as glyceryl oleate, and mixtures thereof.

Examples of anionic surfactants that can be used include in particular: alkaline salts of fatty acids with base, organic or mineral, such as alkaline metal hydroxides (soda or potash), ammonia, or amine(s). The salt may be introduced into the composition or formed in situ.

However, reference to these specific surfactants should not be considered to be limiting.

Advantageously, the method may be implemented using a coating device for food products (1) comprising:
a conveyor belt (2);
a feed reservoir (3) for the coating composition, placed above a first area of said conveyor belt;
a drying device (6);
a discharge device for discharging the fruits or vegetables (10);

such as:
said feed reservoir (3) of the compound is suited to discharge the said coating compound onto said products (1) placed on a first area of the conveyor (2a) by spilling or dripping and by gravity, and at atmospheric pressure.
the discharge device (10) is capable of receiving the products thus coated upon their exit from the conveyor (2) in a second area.

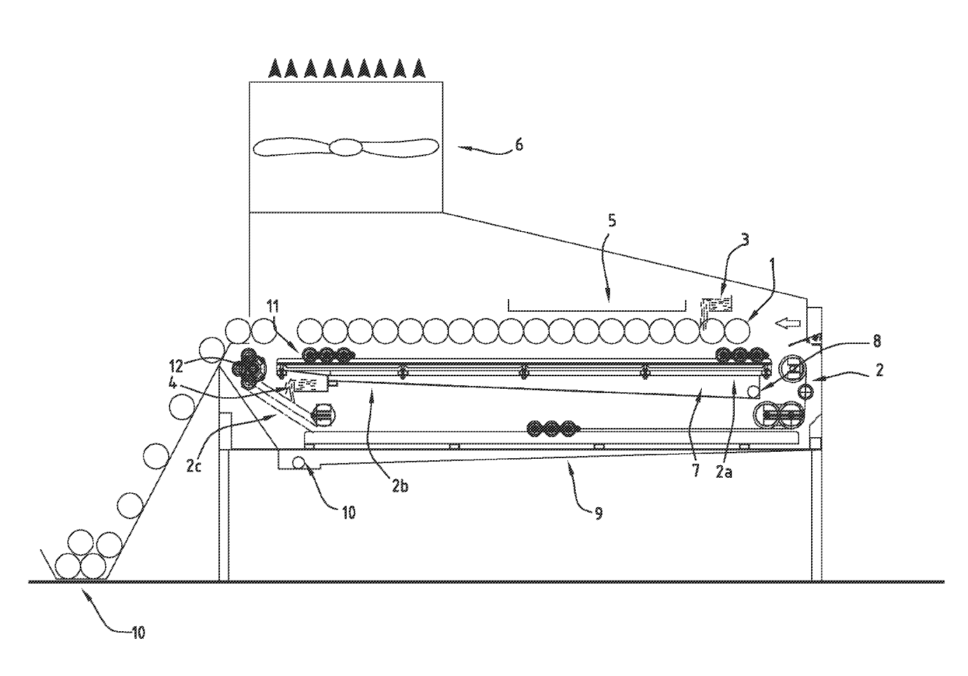

The numerals placed in parentheses refer to FIG. 1, which depicts a device illustrating an example embodiment of the present invention.

The device additionally includes, in preferable embodiments, one or other of the following or each of their combinations:

a washing device for washing the conveyor. Thus, if the conveyor is rinsed with a solvent, the device also includes a solvent feed reservoir (4). If the conveyor is washed mechanically, the device may also include mechanical brushes. In the case of washing by melting, the device may also include a hot water feed reservoir at a temperature greater to the melting point of the solid residues arising from the coating compound deposited on the conveyor; said hot water feed reservoir may be similar to the solvent feed reservoir disclosed above; or a device for blowing hot air at a temperature greater than the melting point of the solid residues arising from the coating composition deposited on the conveyor; and/or

said solvent feed reservoir (4) is suitable to contain the solvent to wash the conveyor (2) after the exit of the products from the conveyor. The device may also include devices (9), (10) to recycle the solvent into the solvent feed reservoir (4) after washing the conveyor. Thus, after showering the empty conveyor (2c), the solvent drips off and is collected on an inclined plane (9) that, at its lowest point, collects the solvent by gravity. A solvent return system (10), such as a pump, then reinjects the solvent into the feed reservoir (4) and/or

the solvent feed reservoir (4) is located on an inclined plane (7); and/or

the solvent feed reservoir (4) is suited to drop, by spilling or dripping, or by gravity, the alcohol on a third area of the conveyor (2c); and/or

a recovery device to recover the extracted solvent vapors. This may include a receptacle containing water into which the extracted solvent is directed. The solvent is thus absorbed by water, and is not discharged into the atmosphere;

a device (5) to limit the evaporation of the solvent during the showering of said products or shortly after showering them, while they are located on the first area (2a) of the conveyor. In fact, it may be desirable to limit the action of the extraction device (6) to ensure better coating. Thus, the device (5) may include, in particular, a plate, located above said products in area (2a) of the conveyor. The size of this plate depends, in particular, on the time necessary for drying the compound on said products, and thus corresponds to the distance that must be traversed by the conveyor; and/or

a device for recycling said compound into the compound feed reservoir (3) after showering said products. Thus, after showering said products (1) on the conveyor (2a), the compound drips off and is collected on an inclined plane (7) that, at its lowest point, collects the solvent by gravity. A return system for the compound (8), such as a pump, then reinjects the compound into the feed reservoir (3) and/or

the conveyor (2) is preferably a wheel conveyor (11), moving from the first area (2a), located under the compound feed reservoir (3) toward a second, opposite, area (2b) in which said products are moved towards a bucket (10) by gravity; and/or

the speed of advancement of the conveyor may be adjusted based on various parameters, such as the rate of flow of said products upon their entry or the rate desired upon their exit, the time necessary for said products to pass through the first area (2a), under the pouring of the coating compound to obtain sufficient showering and satisfactory coating. Thus, the speed of advancement of the conveyor may generally range between 1 m and 10 m/minute and/or

the coating compound feed reservoir includes a device suited to uniformly distribute the compound by spilling and by gravity on the products in area (2a); and/or

the device suited to uniformly distribute the compound by spilling and by gravity onto the products in area (2a) are reeds placed perpendicularly to the direction of movement of the conveyor (2); and/or

said drying device includes a vapor extractor, aspirator, blower, and/or a fan and/or an additional length of conveyor, and/or

a device for automatically controlling the concentration and/or pH of the coating compound;

and/or

said device for automatically controlling the concentration include a densimeter and a feed reservoir for diluted compound (3), such that, when the densimeter indicates that the coating compound has a density greater than the maximum allowed density (i.e., an excessively concentrated coating compound), a diluted coating compound (e.g., density between 1/20 and 1/15 of the density of the coating compound used) is then added to the feed reservoir for the coating compound used, such that the coating compound resulting from the mixture has an appropriate density, less than the maximum allowed density.

According to an example embodiment, the method includes the following stages:
loading said products (1) onto a conveyor (2);
showering said products (1), located in a first area of the conveyor (2a) at atmospheric pressure by pouring or dripping a coating compound contained in a feed reservoir for said compound (3), said reservoir being located above said first area of the conveyor (2a);
passing said products (1), thus coated, through the conveyor (1) in a second area (2b) towards discharge device (10);
unloading said products, thus coated;

and
drying said products, thus coated;

The method may additionally include one of the following stages or any of their combinations:

washing the conveyor (2) after the unloading of said products in a third area (2c). The washing may be carried out by rinsing with solvent, by pouring or dripping the solvent contained in an alcohol feed reservoir (4), this reservoir being located above said third area of the conveyor (2c); or mechanically, e.g., by brushes; or by melting, by rinsing with hot water at a temperature greater than the melting point of the solid residues arising from the coating compound deposited on the conveyor, or by blowing hot air at a temperature greater than the melting point of the solid residues arising from the coating compound deposited on the conveyor;

recycling the solvent into the solvent feed reservoir (4) after washing the conveyor (2): Thus, after showering the empty conveyor (2c), the solvent drips off and is collected on an inclined plane (9) that, at its lowest point, collects the solvent by gravity. The solvent (10) is then reinjected, e.g., by a pump, into the feed reservoir (4); and/or

extracting the solvent; and/or

recovering the extracted solvent vapors, e.g., by passing the solvent into water; and/or

recycling said compound into the compound feed reservoir (3) after showering said products (1). Thus, after showering said products (1) on the conveyor (2a), the compound drips off and is collected on an inclined plane (7) that, at its lowest point, collects the solvent by gravity. The compound (8) is then reinjected, e.g., by a pump, into the feed reservoir (3); and/or

the atmospheric-pressure showering is carried out by pouring or dripping the coating composition; and/or

the pouring or dripping is uniformly distributed by a system of reeds, placed perpendicularly to the direction of movement of the conveyor; and/or

automatic control of the density and/or pH of the coating compound; and/or

the addition of a diluted compound (3) to the compound feed reservoir (3): Thus, if the coating compound has a density greater than the maximum allowed density (i.e., an excessively concentrated coating compound), a diluted coating compound (e.g., having a density between 1/20 and 1/15 of the density of the coating compound used) is then added to the feed reservoir for the coating compound used, such that the coating compound resulting from the mixture has an appropriate density, less than the maximum allowed density; and/or

the drying is carried out by vapor extraction, aspiration, blowing, ventilation, and/or said coated products remaining on the conveyor for an extended period of time; and/or

the speed of advancement of the conveyor may be adjusted based on various parameters, such as the rate of flow of said products upon their entry or the rate desired upon their exit, the time necessary for said products to pass through the first area (2a), under the pouring of the coating compound to obtain sufficient showering and satisfactory coating. Thus, the speed of advancement of the conveyor may generally range between 1 m and 10 m/minute

The following examples are illustrative in nature, and are in no way limiting.

### EXAMPLE 1

A solution is prepared by shaking, from 7 g coumarone-indene resin and 93 g hexane. The solution thus obtained is clear and stable.

### EXAMPLE 2

A solution is prepared by shaking from 5.5 g glyceryl abietate resin, 34.5 g ethyl alcohol, and 10 g limonene. The solution thus obtained is clear and stable.

### EXAMPLE 3

A solution is prepared by shaking, from 9 g shellac resin and 91 g ethyl alcohol. The solution thus obtained is clear and stable.

### EXAMPLE 4

A solution is prepared by shaking, from 9 g shellac resin, 89 g ethyl alcohol, and 2 g ammonia. The solution thus obtained is clear and stable.

### EXAMPLE 5

Apples are treated using the device described in FIG. 1, using the compound set forth in examples 3 and 4 as the coating compound.

Thus, to treat 5000 kg of apples, 12 l of the solution is applied. The compound is poured by overflowing the reservoir (3) on the fruits placed on a wheel conveyor, which moves at 4 m/minute.

The fruits thus treated are homogeneously coated. The compound is recycled, and the conveyor is washed using an ethanol solution, which is also recycled.

If the fruits have condensation on their surface, the coating made in example 4 is shinier than that made in example 3, which has a matte appearance.

### EXAMPLE 6

An anionic aqueous emulsion of carnauba is prepared with 18% carnauba, melted at 100° C., and mixed with 4% oleic acid and 3% concentrated ammonia. 75% boiling water is added while shaking until a fluid, translucent emulsion with a pH of approximately 10 is obtained. This emulsion is applied to apples using a device described in FIG. 1 at the dose of 5 l emulsion per ton of apples. Once the emulsion has dried, the wheels are cleaned in the conveyor return area by mechanical brushing.

1-28. (canceled)

29. A method for coating food products, comprising:
applying, on the food products, a compound including at least one filmogenic agents in a solvent, by at least one of (a) showering the food products with the compound at atmospheric pressure and (b) immersion in the compound.

30. The method according to claim 29, wherein the solvent includes at least one of (a) water, (b) an alcohol, and (c) an alkane.

31. The method according to claim 29, wherein the filmogenic agent includes at least one of (a) a resin and (b) a wax.

32. The method according to claim 31, wherein the resin includes at least one of (a) a coumarone-indene resin, (b) a shellac, (c) resins including abietic acid, and (d) an ester of abietic acid.

33. The method according to claim 32, wherein the abietic acid ester includes an abietic acid ester with at least one of (a) glyceryl and (b) pentaerythritol.

34. The method according to claim 33, wherein the resin includes at least one of (a) a resin ester gum, (b) Pexalyn®, (c) Pentalyn®, and (d) Permalyn®.

35. The method according to claim 31, wherein the wax includes at least one of (a) oxidized polyethylene wax, (b) microcrystalline wax, (c) carnauba wax, (d) candelilla wax, and (e) beeswax.

36. The method according to claim 29, wherein the compound includes at least one terpene.

37. The method according to claim 36, wherein the terpene includes a non-oxygenated terpene.

38. The method according to claim 36, wherein the terpene includes at least one of (a) pinene and (b) limonene.

39. The method according to claim 29, wherein the composition includes a base, and the solvent is water soluble.

40. The method according to claim 39, wherein the base includes at least one of (a) ammonia, (b) soda, (c) potash, and (d) amines.

41. The method according to claim 29, wherein the compound is applied after harvesting and before marketing the food products.

42. The method according to claim 29, wherein between 1000 and 5000 cm³ of the solution per ton of food products is applied.

43. The method according to claim 42, wherein between 2 and 10 liters of compound per ton of food products is applied.

44. The method according to claim 29, wherein compound is applied by showering the food products to be coated, placed on a conveyor belt, with the compound at atmospheric pressure.

45. The method according to claim 44, wherein the showering is performed out by at least one of (a) overflowing and (b) dripping from a feed reservoir of the compound.

46. The method according to claim 44, wherein the showered food products are moved by the conveyor onto an unloading device.

47. The method according to claim 29, wherein the filmogenic agent is in solution in a solvent.

48. The method according to claim 47, wherein the compound includes at least one of: (a) solutions of shellac in at least one of (i) an alcohol and (ii) water; (b) solutions of at least one of (i) abietic acid and (ii) abietic acid esters in at least one of (i) an alcohol and (ii) water, at least one of (i) with and (ii) without a terpene; (c) solutions of coumarone-indene resins in at least one of (i) an alkane and (ii) water; (d) solutions of at least one of (a) a lecithin and (b) derivatives in water; (e) solutions of carboxymethylcellulose in water; and (f) solutions of polymerized sugar derivatives in water.

49. The method according to claim 29, wherein the filmogenic agent is in aqueous emulsion.

50. The method according to claim 49, wherein the coating compound includes aqueous emulsions of at least one of (a) oxidized polyethylene wax, (b) microcrystalline wax, (c) carnauba wax, (d) candelilla wax, and (e) beeswax.

51. The method according to claim 29, wherein coating compound includes at least one of (a) compounds of at least one of (i) a resin and (ii) a sucroester used for food purposes, a solvent at least one of (A) one of (i) with and (ii) without an alkaline medium and (B) in the presence of terpenes; (b) compounds of a resin used for food purposes in an alkaline medium in water; and (c) compounds of a wax used for food purposes in anionic aqueous emulsion.

52. The method according to claim 29, wherein the compound includes: (a) between 1% and 35% by weight in resin; (b) between 0% and 50% by weight in terpene; (c) between 15% and 99% by weight in solvent; and (d) between 0 and 10% by weight of base.

53. The method according to claim 29, wherein the coating compound includes at least one of (a) coumarone-indene in hexane; (b) glyceryl abietate in ethyl alcohol; and (c) shellac in ethyl alcohol; one of (a) with and (b) without at least one of (a) limonene and (b) a base.

54. The method according to claim 29, wherein the compound includes at least one of (a) a solvents, (b) a vegetable oil, and (c) an emulsifier.

55. The method according to claim 29, wherein the food products include at least one of (a) fruit, (b) a vegetable, (c) a cheese, and (d) an egg.

56. A coating compound for food products, comprising:
between 1% and 35% by weight in a resin;
between 0% and 50% by weight in a terpene;
between 15% and 99% by weight in a solvent; and
between 0.1 and 10% by weight of base.
